(19) United States
(12) Patent Application Publication
(10) Pub. No.: US 2012/0308774 A1
(43) Pub. Date: Dec. 6, 2012

(54) METHOD OF PRODUCING A POWDER LAYER OR A GRANULAR LAYER

(75) Inventors: Niclas HÅKANSSON, Viken (SE); Hans PERSSON, Perstorp (SE); Peter STJERNA, Munka-Ljungby (SE); Peter WINGÅRDH, Wolouve Saint-Pierre (BE)

(73) Assignee: CeraLoc Innovation Belgium BVBA, Brussels (BE)

(21) Appl. No.: 13/469,799

(22) Filed: May 11, 2012

Related U.S. Application Data
(60) Provisional application No. 61/485,930, filed on May 13, 2011.
(60) Provisional application No. 61/557,643, filed on Nov. 9, 2011.

(30) Foreign Application Priority Data
May 13, 2011 (SE) 1150435-4
Nov. 9, 2011 (SE) 1151057-5

(51) Int. Cl. B05D 7/24; B05C 1/00; B32B 5/16; B05D 3/02

(52) U.S. Cl. 428/143; 427/180; 118/200

(57) ABSTRACT

A method for producing a panel including scattering of a wood fibre powder on a carrier is disclosed and a device for the scattering step.

### TECHNICAL FIELD

The disclosure generally relates to a method of producing a powder layer or a granular layer on a carrier, a scattering station for producing a powder layer or a granular layer on a carrier and a building panel produced by said method.

### BACKGROUND

Recently new “paper free” Wood Fibre Floor (WFF) types of flooring have been developed with solid surfaces comprising a substantially homogenous mix of fibres, binders and wear resistant particles. Such a new type of panel called Wood Fibre Floor (WFF) is disclosed in WO2009/065769, which shows both products and methods to produce such a product.

The wear resistant particles are preferably aluminium oxide particles, the binders are preferably thermosetting resins such as amino resins and the fibres are preferably wood based. Other suitable wear resistant materials are for example silica or silicon carbide. In most applications decorative particles such as for example colour pigments are included in the homogenous mix. In general, all these materials are preferably applied in dry form as a powder mix on a carrier and cured under heat and pressure to a 0.1-1.0 mm solid layer. The powder mix is scattered by means of an applying device, for example comprising a rotating roller with needles such as disclosed in WO2009/124704.

When applying a powder mix comprising a substantially homogenous mix of fibres, binders and wear resistant particles to form a powder mix layer on a carrier, for example by the methods described in WO2009/065769 or in WO2009/124704, one problem which may occur is that the powder mix layer is unevenly distributed on the carrier. An uneven distribution of the powder mix creates a surface having various defects. Such defects may relate to decorative properties, for example undesired colour variations. Due to the uneven distribution of powder, the layer obtains an uneven thickness, which may make forming a mechanical locking system at edges of the floor panel difficult. In order to secure a sufficient minimum thickness of the layer, extra powder is applied compared to if it would have been possible to scatter the powder with a uniform thickness, thus forming a layer being thicker at some portions. This is undesired due to excess consumption of powder and due to problem relating to balancing of the floor panel.

### SUMMARY OF THE INVENTION

It is an object of the present invention to provide an improvement over the above described techniques and prior art.

A further object of certain embodiments of the disclosure is to provide a scattering station and a production method that creates an improved distribution of a powder layer or a granular layer on a carrier.

At least some of these and other objects and advantages that will be apparent from the description have been achieved by a method of producing a powder layer or a granular layer according to a first aspect of the invention. The method comprising the steps of:
feeding a powder or granules to a rotating roller;
feeding of the powder or the granules to a first oscillating device;
feeding of the powder or the granules to a second oscillating device, the second oscillating device oscillates in another direction than the first oscillating device; and
moving a carrier under the first and the second oscillating devices to obtain a powder layer or a granular layer on the carrier.

By using a first and a second oscillating device, which oscillates in two different directions, the scattered area is increased and the distribution of the powder or granules on the moving carrier is improved and an evenly distributed powder layer or a granular layer is obtained.

By oscillate or oscillating is also included vibrational movements. By oscillating is included both controlled and uncontrolled oscillating movements. The oscillating movement of the first oscillating device may be linear. The oscillating movement of the second oscillating device may be linear, rotational, circular and/or elliptic. If the oscillating movement of the second oscillating device is non-linear, e.g., rotational, circular and/or elliptic, the second oscillating device may have a primary oscillating direction being different from the primary oscillating direction of the first oscillating device.

The method is preferably executed in the order as listed.

The first oscillating device may oscillate in a direction essentially perpendicular to the moving direction of the carrier.

The second oscillating device may oscillate in a direction essentially parallel to the moving direction of the carrier.

The first and/or the second oscillating device may comprise a first and/or a second oscillating unit. Each oscillating unit preferably comprises a net, e.g. with crossing elements, or a mesh, e.g. of an expanded metal mesh, or thread-shaped elements, e.g. wires or lines, that are not crossing, i.e. are running parallel, in one direction only. The thread-shaped elements are preferably running in a direction perpendicular to the oscillating direction and are preferably mounted in a frame. The effect of the thread-shaped element running in one direction only and oscillating in a direction perpendicular to the oscillating direction is that the distribution of the powder is further improved. A net with crossing element may create lines in applied the powder layer. As an alternative to the mesh and the thread-shaped elements, a plate with several apertures may be used. As a further alternative, a plate or sheet without apertures may be used.

The first and the second oscillating units are preferably oscillating with a phase shift, preferably with a 180° phase shift.

The second oscillating device may impact against at least one mechanical stop.

The method may further comprise the step of curing the powder layer or the granular layer by applying heat and pressure. The thickness of the cured layer may be 0.01-2 mm. The thickness of the cured layer is preferably less than about 1 mm and preferably less than about 0.3 mm.

The carrier may for example be a conveyor, a paper or an MDF or HDF board.

A second aspect of the invention is a building panel, e.g. a floor panel, with a decorative surface layer and/or a balancing layer produced by the method above. The building panel may comprise a core, preferably a wood fibre based core, and a decorative surface layer and/or a balancing layer produced by the method above attached to the core.

A third aspect of the invention is a scattering station, for producing a powder layer or a granular layer, comprising a rotatable roller and a first and a second oscillating device that are able to oscillate. The second oscillating device is configured to oscillate in another direction than the first oscillating device. The scattering station is configured such that powder or granules are applied on a carrier, which is fed under the roller, and the first and a second oscillating device.

The first oscillating device may be configured to oscillate in a direction essentially perpendicular to the moving direction of the carrier.

The second oscillating device may be configured oscillate in a direction essentially parallel to the moving direction of the carrier.

The first and/or the second oscillating device may comprise a first and/or a second oscillating unit. Each oscillating unit preferably comprises a net, e.g. with crossing elements, or a mesh, e.g. of an expanded metal mesh, or thread-shaped elements, e.g. wires or lines, that are not crossing, running in one direction only. The thread-shaped elements are preferably running in a direction perpendicular to the oscillating direction and are preferably mounted in a frame. The first and the second oscillating unit are preferably oscillating with a phase shift, preferably with a 180° phase shift. As an alternative to the mesh and thread-shaped elements, a plate with several apertures may be used. As a further alternative, a plate or sheet without apertures may be used.

The first oscillating device is according to one embodiment positioned above the second device.

The first oscillating device may have a fastening device behind the roller, as seen in the feeding direction.

The second oscillating device may have a fastening device in front of the roller, and the second device preferably extends under the roller and under the first device.

Preferred embodiments of the first, the second and the third aspect of the invention are defined in the sub-claims below and under the detailed description of embodiments.

The oscillating frequencies in the aspects above may be in the range of about 5 to about 2000 Hz. The amplitude of the oscillating movements in the aspects above may be in the range of 0.01-10 mm.

The powder in the aspects above may be replaced by a granulation.

The methods above might be used to any production of a building panel in which a dry powder layer is applied to a core.

### BRIEF DESCRIPTION OF THE DRAWINGS

The disclosure will in the following be described in connection to preferred embodiments and in greater detail with reference to the appended exemplary drawings, wherein

FIG. 1 Illustrates a perspective view of a scattering station according to an embodiment of the disclosure;

FIG. 2 Illustrates a scattering station according to an embodiment of the disclosure;

FIG. 3 Illustrates a scattering station according to an embodiment of the disclosure;

FIG. 4 Illustrates a scattering station according to an embodiment of the disclosure;

FIG. 5 Illustrates a scattering station according to an embodiment of the disclosure;

FIG. 6a illustrates a net.

FIG. 6b illustrates an expanded metal mesh.

FIG. 6c illustrates a member comprising thread-shaped elements running parallel.

### DETAILED DESCRIPTION OF EMBODIMENTS

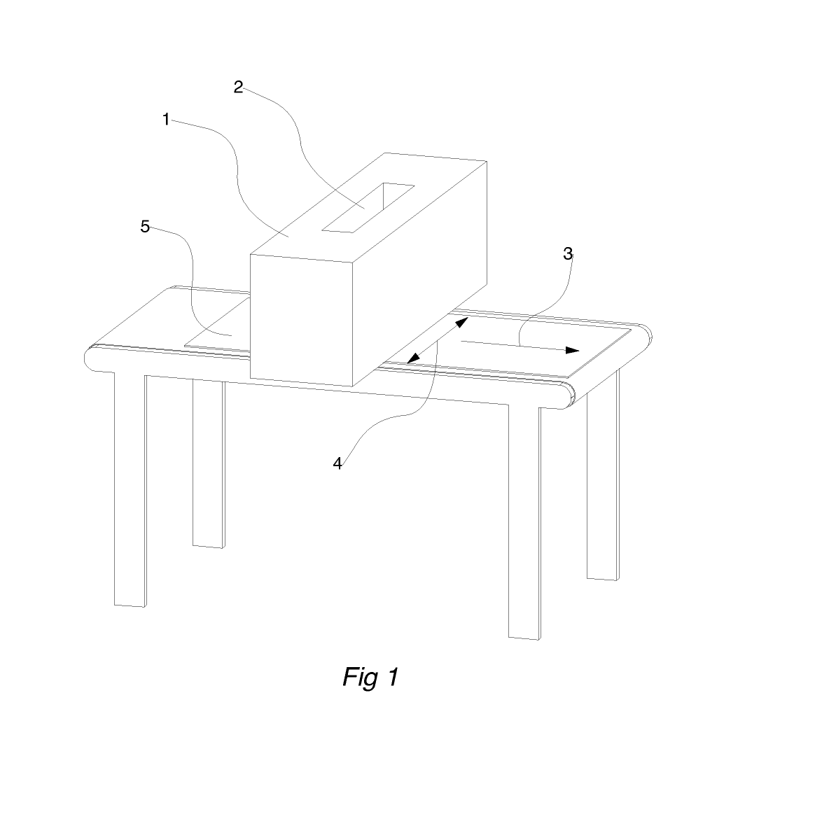

In FIG. 1, a perspective view of an embodiment of a scattering station 1 is shown. A powder mix or granules in a container is feed by a hopper 2 and applied on a carrier 5, e.g. an MDF/HDF board fed by a conveyor belt in a feeding direction 3 and under the scattering station.

The powder mix may comprise fibres, preferably wood fibres, and a binder, preferably a thermosetting binder such as melamine. The wood fibres may be may be both virgin, unrefined, refined and/or processed, comprising lignin and without lignin, e.g. a-cellulose fibres or holocellulose. A mixture of refined and unrefined fibres may also be used. The powder has a particle size of 1-400 μm. The powder mix may comprise particles of different sizes within the above defined range.

As an alternative, granules are fed by the hopper 2 and applied on the carrier 5. Each granule may comprise fibres, preferably wood fibres, and a binder, preferably a thermosetting binder such as melamine. The wood fibres may be may be both virgin, unrefined, refined and/or processed, comprising lignin and without lignin, e.g. a-cellulose fibres or holocellulose. A mixture of refined and unrefined fibres may also be used. The granules may have a particle size of 50-500 μm. The granules applied on the carrier preferably have a uniform size.

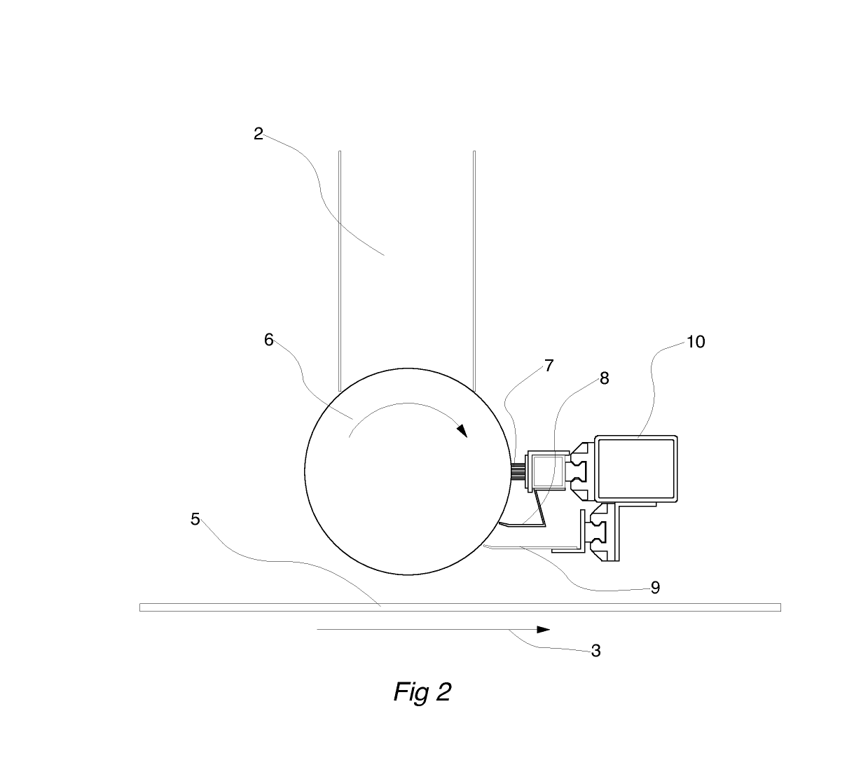

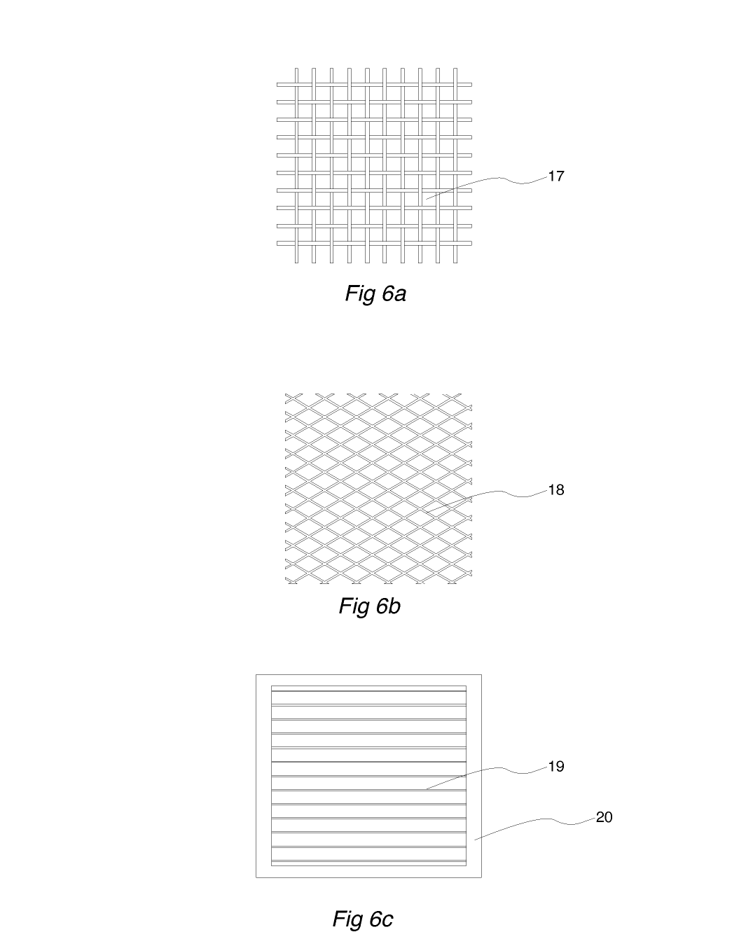

FIG. 2 shows an embodiment of a scattering station. The scattering station comprises a hopper 2 that feeds the powder mix or granules to a roller 6. The roller is preferably provided with needles. A needle belt 7 or a brush removes the powder from the roller, wherein the powder or granules is fed to a first oscillating device. The first oscillating device may comprise a first and a second oscillating unit, e.g. an upper 8 and a lower net 9. The upper and lower nets 8, 9 are preferably of the type shown in FIG. 6a. The first and the second oscillating units of the first oscillating device oscillate in the same direction 4 perpendicular to the feeding direction 3 of the carrier. Preferably, the oscillating movement of the first oscillating device is linear. The first and the second oscillating unit may oscillate with a phase shift. The needle belt and the roller are mounted on a beam 10.

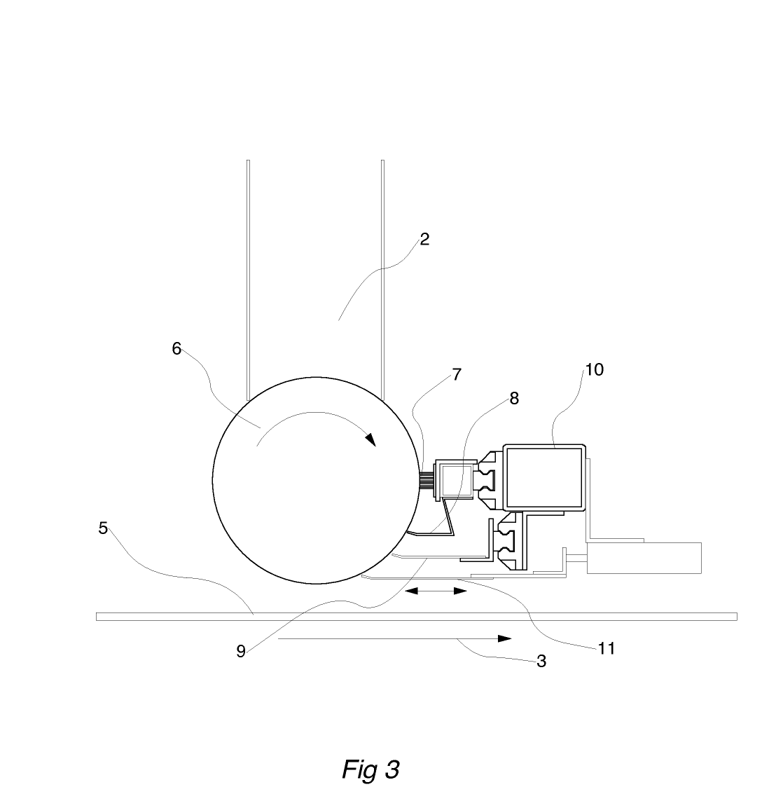

In FIG. 3, an embodiment of a scattering station comprising a first and a second oscillating device is shown. The second oscillating device comprises a mesh 11. The mesh 11 is preferably an expanded metal mesh of the type shown in FIG. 6b. The second oscillating device is mounted on the beam 10, which is behind the roller seen in feeding direction. The first oscillating device is of the type described above with reference to FIG. 2. The first oscillating device is arranged above the second oscillating device. The first oscillating device comprises in the shown embodiment a first and a second oscillating unit, e.g. an upper 8 and a lower net 9. The upper and lower nets are of the types shown in FIG. 6a. The first oscillating device is adapted to oscillate in a first direction, preferably in a linear direction. The second oscillating device is adapted to oscillate in a second direction being different from the first direction. The oscillating movement of the second oscillating device may be linear, rotational, circular or elliptic. The first oscillating device preferably oscillates in a direction 4 perpendicular to the feeding direction 3 of the carrier. The second oscillating device 11 preferably oscillates in a direction parallel to the feeding direction 3 of the carrier. If the oscillating movement of the second oscillating device is non-linear, a primary oscillation direction of the second oscillating device is different and preferably perpendicular to the oscillating direction of the first oscillating device. The first and the second oscillating units of the first oscillating device oscillate in the same direction, preferably perpendicular to the feeding direction 3 of the carrier. The first and the second oscillating units may oscillate with a phase shift, preferably with a 180° phase shift.

Alternatively, the second oscillating device may comprise a member comprising thread-shaped elements not crossing, i.e. running parallel. The member is preferably of the type shown in FIG. 6c. The thread-shaped elements are preferably extending perpendicular to the feeding direction 3 of the carrier 5. The first oscillating device is of the type described above with reference to FIG. 3. The first oscillating device is adapted to oscillate in a first direction, preferably in a linear direction. The second oscillating device is adapted to oscillate in a second direction being different from the first direction. The oscillating movement of the second oscillating device is preferably linear. The first oscillating device preferably oscillates in a direction 4 perpendicular to the feeding direction 3 of the carrier. The second oscillating device 11 preferably oscillates in a direction parallel to the feeding direction 3 of the carrier.

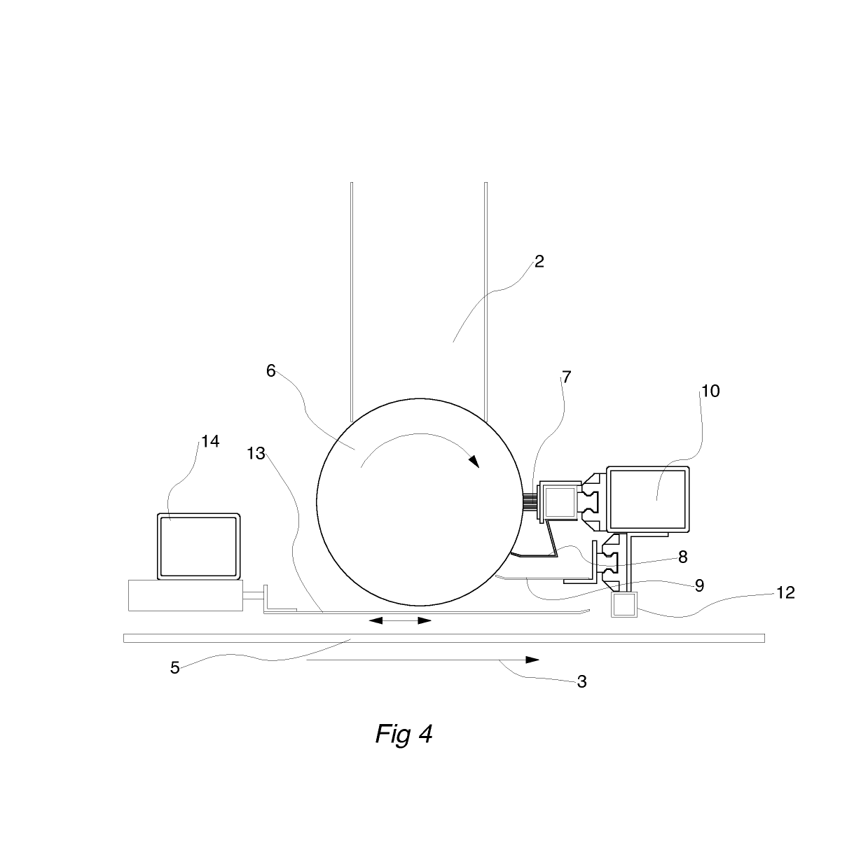

In FIG. 4, an embodiment of a scattering station is shown. The scattering station comprises a first and second oscillating device. The first oscillating device is of the type described above with reference to FIGS. 2 and 3, e.g. comprising an upper 8 and lower 9 net. The second oscillating device comprises a net 13.

The net 13 is preferably of the type shown in FIG. 6a. The net 13 is mounted on another beam 14, which is before the roller seen in feeding direction. The net 13 extends under roller and the first oscillating device. The first oscillating device is adapted to oscillate in a first direction, preferably in a linear direction. The first and the second oscillating units of the first oscillating device oscillate in the same direction, preferably perpendicular to the feeding direction 3 of the carrier. The first and the second oscillating units may oscillate with a phase shift, preferably with a 180° phase shift. The second oscillating device preferably oscillates in a direction parallel to the feeding direction 3 of the carrier. More preferably, the second oscillating device oscillates with a rotational, circular or elliptic movement. A primary oscillation direction of the second oscillating device is different and preferably perpendicular to the oscillating direction of the first oscillating device.

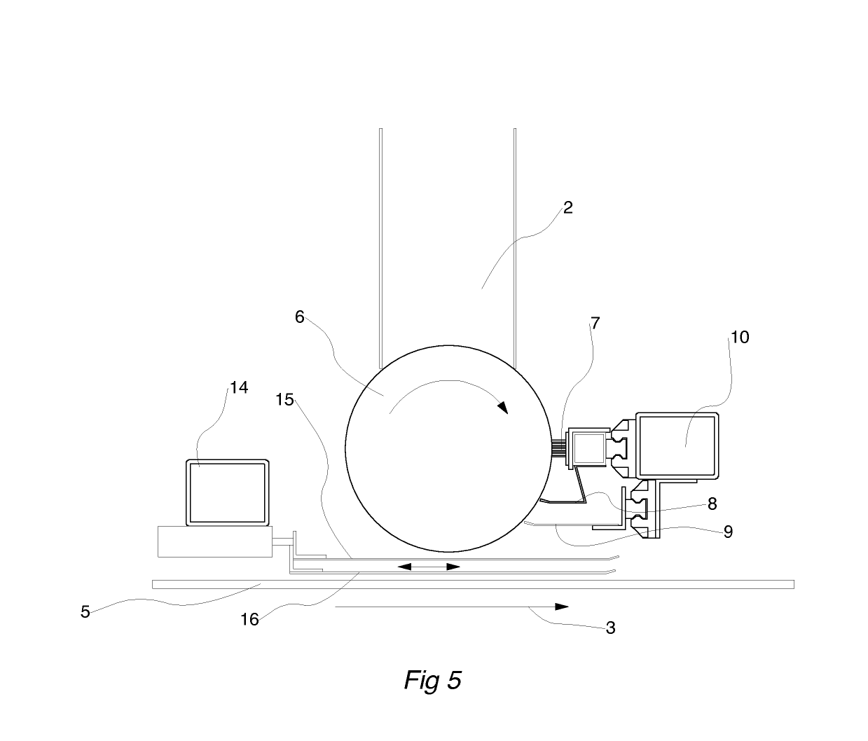

FIG. 5 shows an embodiment wherein both the first and second oscillating devices comprise a first and second oscillating unit. The first oscillating device is of the type described above with reference to FIGS. 2 and 3. The second oscillating device comprises a first and a second oscillating unit. The first and the second oscillating unit of the second oscillating device may be a first and a second net 15, 16. The first and the second oscillating units of the second oscillating device oscillate in the same direction, preferably parallel to the feeding direction 3 of the carrier. Alternatively, the first and second units may be a first and second mesh, such as an expanded metal mesh, or a member with parallel thread-shaped elements.

FIG. 6a shows a net 17. The net 17 is made of crossing elements. The elements are interwoven. The elements are preferably crossing perpendicularly with each other.

Preferably, the first oscillating device comprises a net 17 of the type shown in FIG. 6a. More preferably, the first unit of the first oscillating device comprises a net 17 of the type shown in FIG. 6a. Also the second unit of the first oscillating device comprises preferably a net 17 of the type shown in FIG. 6a. Preferably, the first and the second oscillating units in form of the nets oscillate in a linear direction, more preferably perpendicular to the moving direction 3 of the carrier 5. Preferably, the first and the second oscillating units oscillate with a phase shift, for example 180°.

Also the second oscillating device may comprise a net 17 of the type shown in FIG. 6a. The oscillating movement of the second oscillating device in form of the net 17 is preferably rotational, circular or elliptic.

FIG. 6b shows an expanded metal mesh 18. The expanded metal mesh comprises openings having a shape of a rhomb. The second oscillating device may comprise an expanded metal mesh 18 of the type shown in FIG. 6b. The oscillating movement of the second oscillating device in form of the expanded metal mesh 18 may be linear, rotational, circular or elliptic.

FIG. 6c shows a member 19 comprising thread-shaped elements, e.g. wires or lines, that are not crossing. The thread-shaped elements extend in one direction only. The thread-shaped elements are running parallel. The thread-shaped elements are mounted in a frame 20. The second oscillating device may comprise a member 19 of the type shown in FIG. 6c. Preferably, the second oscillating device in form of the member 19 oscillates in a linear direction, more preferably parallel to the moving direction 3 of the carrier 5. Preferably, the thread-shaped elements of the member 19 extend in a direction perpendicular to the moving direction 3 of the carrier 5.

The scattering station 1 of the above described embodiments may comprise at least one mechanical stop 12. Such a mechanical stop is shown in FIG. 4. Said at least one mechanical stop 12 may be resilient. The second oscillating device is adapted to impact against said at least one mechanical stop 12 such that powder, granules or dust remaining on the second oscillating device falls off the second oscillating device by inertia. Thereby, a self-cleaning function of the second oscillating device 11, 13, 15, 16 is obtained. The oscillating movement of the second oscillating device 11, 13, 15, 16 provides a linear transporter and/or smooth movement which is broken by the mechanical stop 12 in order to form the self-cleaning function.

As an alternative to providing a mechanical stop, the oscillating motion of the second oscillating device 11, 13, 15, 16 in a direction opposite to the feeding direction may be faster, for example 10-30 times faster, than the oscillating motion in the feeding direction. Thereby, any remaining powder, granule or dust may fall off the second oscillating device 11, 13, 15, 16 such that a self-cleaning function is obtained.

The mesh in the first and the second oscillating devices in the embodiments above may be replaced with plates with several apertures, or a frame with wires or lines, e.g. steel wires, nylon lines e.g. fisher lines, not crossing and running in one direction only, preferably perpendicular to the oscillating direction.

In one embodiment, the second oscillating device comprises a plate or sheet. The plate or sheet may have a closed surface, i.e. having a surface without apertures. The plate or sheet may be extending in a direction parallel to the extension of the carrier or may be angled, for example 1-10°, in relation to the extension of the carrier and in a direction perpendicular to the extension of the carrier. The plate or sheet is adapted to oscillate. The plate or sheet may oscillate in a direction parallel to the feeding direction of the carrier. Preferably, the oscillating motion in a direction opposite to the feeding direction is faster, for example 10-30 times faster, than the oscillating motion in the feeding direction. Alternatively, the plate or sheet is arranged to impact against a mechanical stop.

A person skilled in the art appreciates that the powder described above may be replaced by granules for forming a granular layer, and that the inventive method may be used also for producing a granular layer.

As a non-limiting example, the steps for producing a WFF board, using the method of producing a powder layer as described above, may be as follows:
1) Positioning of a balancing layer, e.g. a paper impregnated with a thermosetting resin or a mixture of wood powder and thermosetting resin is placed on a conveyor belt. A typical balancing layer is two sheets of DKB 140 paper.
2) Place a wood fibre board, typically an about 10 mm thick HDF board with a density of typically about 900 kg/m3, on top of the balancing layer 3) Moving the balancing layer and board in a speed of about 1-10 m/min (a typical value is about 3 m/min) under a scattering station were a premade mixture of wood fibres, binders, hard particles and pigments are scattered on top of the board. The powder applied can be in the range of about 100-1000 g/m2. Typical value may be about 700 g/m2.

4) Preferably stabilizing the power layer by applying moisture and/or heat.

5) Bringing the board with a balancing layer on the backside and a scattered powder layer on the top side into the press.

6) Closing the press, and curing the thermosetting resin in the balancing layer and the powder layer under heat and pressure. Typical press parameters are about 30 seconds pressing (range for example about 8-60 seconds). 40 bars pressure (range for example about 30-60 bars) applied on the board. Temperature of typically about 170 degrees C. (range about 150-220 degrees C.) on the top and bottom press plates. The press plates can be even or have structure. Structure depth typically about 0.5 mm (range for example about 0-1.5 mm)

In an alternative example also one or more paper sheets are applied after step 4.

It is contemplated that there are numerous modifications of the embodiments described herein, which are still within the scope of the invention as defined by the appended claims. For example, it is contemplated that more than one layer may be scattered by the inventive method on the carrier. For instance, a second powder or granular layer may be scattered on top of a first powder or granular layer.

1. A method of producing a powder layer or a granular layer comprising the steps of:
feeding a powder or granules to a rotating roller;
feeding of the powder or the granules to a first oscillating device;
feeding of the powder or the granules to a second oscillating device, the second oscillating device oscillates in another direction than the first oscillating device; and
moving a carrier under the first and the second oscillating devices to obtain a powder layer or a granular layer on the carrier.

2. The method as claimed in claim 1, wherein the first oscillating device oscillates in a direction essentially perpendicular to the moving direction of the carrier.

3. The method as claimed in claim 1, wherein the second oscillating device oscillates in a direction essentially parallel to the moving direction of the carrier.

4. The method as claimed in claim 2, wherein the second oscillating device oscillates in a direction essentially parallel to the moving direction of the carrier.

5. The method as claimed in claim 1, wherein the second oscillating device impacts against at least one mechanical stop.

6. The method as claimed in claim 1, wherein the first oscillating device comprises a first and a second oscillating unit.

7. The method as claimed in claim 6, wherein the first and the second oscillating units oscillate with a phase shift.

8. The method as claimed in claim 7, wherein the phase shift is a 180° phase shift.

9. The method as claimed in claim 1, wherein the second oscillating device comprises a first and a second oscillating unit.

10. The method as claimed in claim 1, wherein the method further comprises the step of curing the powder layer or the granular layer by applying heat and pressure.

11. The method as claimed in claim 1, wherein the carrier is a wood fibre based core.

12. The method as claimed in claim 11, wherein the wood fibre based core is an HDF or an MDF panel.

13. The method as claimed in claim 1, wherein the carrier and the powder layer or the granular layer constitutes a floor panel.

14. The method as claimed in claim 1, wherein the powder layer or the granular layer comprises wear resistant particles, a binder, and wood fibres.

15. A floor panel comprising a powder layer or a granular layer produced according to the method in claim 1.

16. A scattering station for producing a powder layer or a granular layer, comprising
a rotatable roller and
a first and a second oscillating device being able to oscillate, wherein the second oscillating device is configured to oscillate in another direction than the first oscillating device, and wherein the scattering station is configured such that powder or granules are applied on a carrier, which is fed under the roller and the first and the second oscillating device.

17. The scattering station according to claim 16, wherein the first oscillating device is configured to oscillate in direction essentially perpendicular to a moving direction of the carrier.

18. The scattering station according to claim 17, wherein the second oscillating device is configured to oscillate in a direction essentially parallel to the moving direction of the carrier.

19. The scattering station according to claim 16, wherein the first oscillating device comprises a first and a second oscillating unit.

20. The scattering station according to claim 19, wherein the first and the second oscillating units oscillate with a phase shift.

21. The scattering station according to claim 20, wherein the phase shift is a 180° phase shift.
